(19) United States
(12) Patent Application Publication
(10) Pub. No.: US 2003/0127093 A1
(43) Pub. Date: Jul. 10, 2003

(54) Oxygen containment enclosure

(76) Inventor: Annie F. Maniscalco, Studio City, CA (US)

Correspondence Address: ALBERT O COTA, 5460 WHITE OAK AVE, SUITE A-331, ENCINO, CA, 91316, US

(21) Appl. No.: 10/040,028

(22) Filed: Jan. 8, 2002

(51) Int. Cl. A62B 18/00

(52) U.S. Cl. 128/201.23; 128/201.22

(57) ABSTRACT

An oxygen containment enclosure (OCE) (10) that is comprised of a face mask (12) which is substantially dimensioned to fit over a person's face. The face mask (12) has a receptacle bore (24) into which is inserted and attached an oxygen input receptacle (26). An oxygen source (32) having a hose with a connector (34) is attached to the input receptacle (26) to provide oxygen that is applied through the face mask (12) and onto the person's face (90). A plurality of air circulation bores (30) are located on the face mask (12) to allow ambient air and the oxygen that is applied to circulate. The OCE 10 is designed to provide a means by which sterile or non-sterile oxygen can be applied to and contained proximate to a person's face during procedures such as an oxygen therapy facial treatment. To insure that the face mask (12) is sterile prior to use, a peel-off film (36) is located on the face mask's (12) inner surface (16).

### TECHNICAL FIELD

The invention pertains to the general field of oxygen therapy, and more particularly to oxygen therapy which utilizes an oxygen containment enclosure, such as a face mask, which allows oxygen to flow and be maintained over a person's face.

### BACKGROUND ART

The ability to cleanse and treat a person's skin has long been utilized to preserve and enhance beauty. A significant number of women and some men, regularly undergo a process, which is typically known as a facial treatment, or just simply a facial. During a facial, a person's face is extensively cleaned, preferably to remove any dirt, excess oil or other undesirable elements from within the skin's pores. By removing the un-desirable elements, the pores are opened and thus more air is allowed to circulate, which produces healthier skin.

One of the most important segments of a complete facial treatment is the application to the face of a deep-cleaning cleanser and toner. A conventional example of this is a facial mask, which is applied to the face as a wet, permeable gel or mud-like substance. Once the facial mask is completely applied over the person's whole face (and often neck), the mask is allowed to dry and harden. It is during the drying and hardening period that the mask performs its function. After a duration of time, the mask is removed, thus leaving the person's skin clean and healthy looking.

It has been found that by using pure oxygen, rather than ambient air, many facial masks function much more effectively. It has also been found that by applying pure oxygen to a person's face for an extended time period helps to rejuvenate the skin and is also beneficial to the skin's health.

Unfortunately, it is difficult to apply oxygen to a person's face because the oxygen must come from a pressurized source and once released into the air, the oxygen dissipates very quickly. If the oxygen is placed very close to a person's face during application, the pressure of the released oxygen hitting the face can be un-comfortable or painful.

There is an obvious need for a means by which oxygen can be quickly, easily and sanitarily applied to a person's face, especially during a facial treatment. The oxygen must be allowed to permeate into the skin or a facial mask, while being applied and maintained for extended periods of time.

A search of prior art literature did not disclose any oxygen containment enclosures that read directly on the claims of the instant invention.

### DISCLOSURE OF THE INVENTION

The oxygen containment enclosure is preferably configured as a face mask into which is applied a controlled source of oxygen. The oxygen contained within the mask is dispersed over the face during an oxygen therapy facial treatment.

In its most basic design, the oxygen containment enclosure is comprised of a face mask that is substantially contoured and dimensioned to fit over a person's face. The face mask is further comprised of:

an outer surface, an inner surface, a perimeter edge, and a receptacle bore,

an oxygen input receptacle inserted into and attached to the receptacle bore,

a plurality of air circulation bores, and

an oxygen source having a hose with a connector designed to be attached to the oxygen input receptacle.

The face mask is preferably made of a composite structure that includes an outer layer made of relatively thin clear plastic, and an inner layer consisting of a peel-off film. The outer layer further has a plurality of air circulation bores that allow a person who is wearing the face mask to breathe the ambient air around their face, in addition to the oxygen that is being applied. The air circulation bores also provide a means by which oxygen that has been applied into the face mask can escape, thus providing displacement for new oxygen to be applied. The peel-off film is removed prior to placing the face mask over a client's face. Thus assuring the client that a sanitized face mask is been used.

In order to supply the oxygen that is applied to the face mask, the oxygen source is utilized. The oxygen source is typically comprised of either a portable oxygen bottle or a stationary oxygen supply. Regardless of which oxygen source is employed, a hose extends from the source that terminates with a connector. The connector is designed to allow the hose to be quickly and securely attached to the oxygen input receptacle located on the face mask.

In view of the above disclosure, it is the primary object of the invention to provide a face mask which allows sterile or non-sterile oxygen to be applied to and contained in close proximity to a person's face, during such procedures as an oxygen therapy facial treatment.

It is also an object of the invention to provide an oxygen containment enclosure that:

can quickly and easily be placed on and removed from a person's face,

can be disposed of after a single use,

can include a removable peel-off liner that insures that the oxygen containment enclosure is sterile prior to use,

can be purchased and stored indefinitely within a small area,

can be manufactured in other shaped structures for use on other parts of a person's body to provide oxygen application and containment, for uses such as treating burn victims, and

is cost effective from both a manufacturer and consumer points of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a side elevational view of a first design configuration for an oxygen containment enclosure which is in the form of a face mask.

FIG. 2 is a front elevational view of the face mask applicable to the first design configuration of the oxygen containment structure.

FIG. 3 is a block diagram of a typical oxygen source that is connected to a hose having attached a connector.

FIG. 4 is a partial side, cross-sectional, elevational view of the peel-off film that is attached to the inner surface of the face mask

FIG. 5 is a side, cross-sectional, elevational view of a second design configuration for an oxygen containment structure which is in the form of a face mask.

FIG. 6 is a front elevational view of the face mask applicable to the second design configuration of the oxygen containment structure.

FIG. 7 is a block diagram of a typical oxygen source that incorporates an oxygen regulating means.

FIG. 8 is a block diagram showing the flow path of the elements that comprise the oxygen containment structure.

### BEST MODE FOR CARRYING OUT THE INVENTION

The best mode for carrying out the invention is presented in terms of a preferred embodiment which is disclosed in two design configurations for an oxygen-containment enclosure 10 (hereinafter “OCE 10”).

The OCE 10 is designed to provide a means by which oxygen can be quickly, easily and accurately applied over a person's face during an oxygen therapy facial treatment. The OCE 10 can be placed over various parts of a human body, but for purposes of description, the OCE 10 is primarily disclosed in terms of a face mask. By applying oxygen to the face during a facial, the desired results are obtained quicker and more completely than when a person's face is simply left open to ambient air.

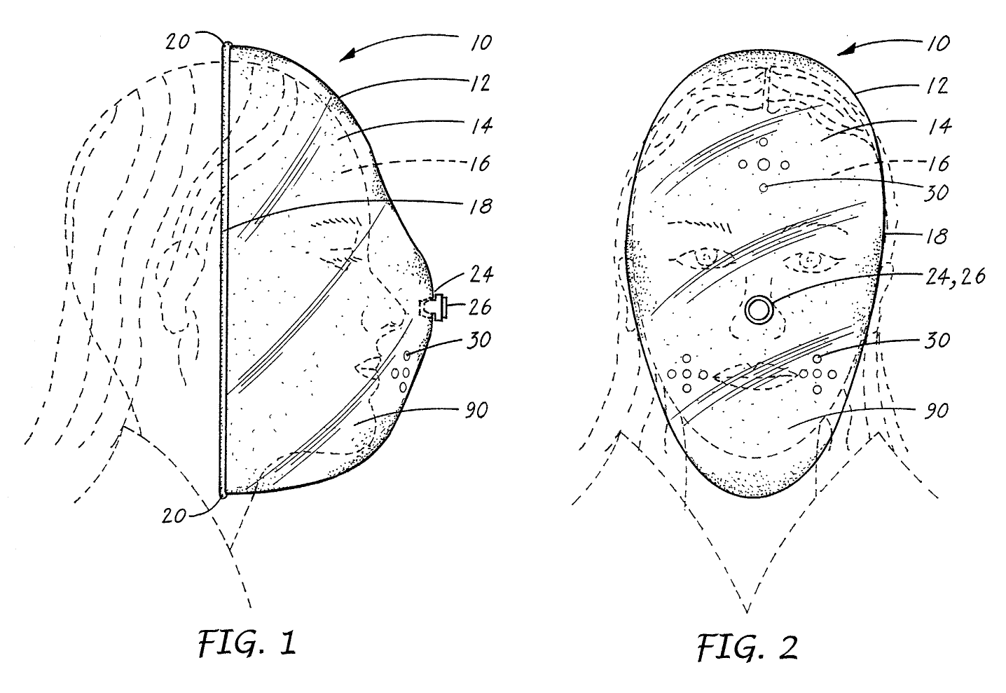

The first design configuration of the OCE 10, as shown in FIGS. 1 and 2, is comprised of a face mask 12, which is substantially contoured and dimensioned to fit over a person's face 90 and to receive a regulated quantity of oxygen that is contained and dispersed over the face 90. The face mask 12 is dimensioned to cover the entire face 90, from the top of the forehead to the bottom of the chin, and from ear to ear.

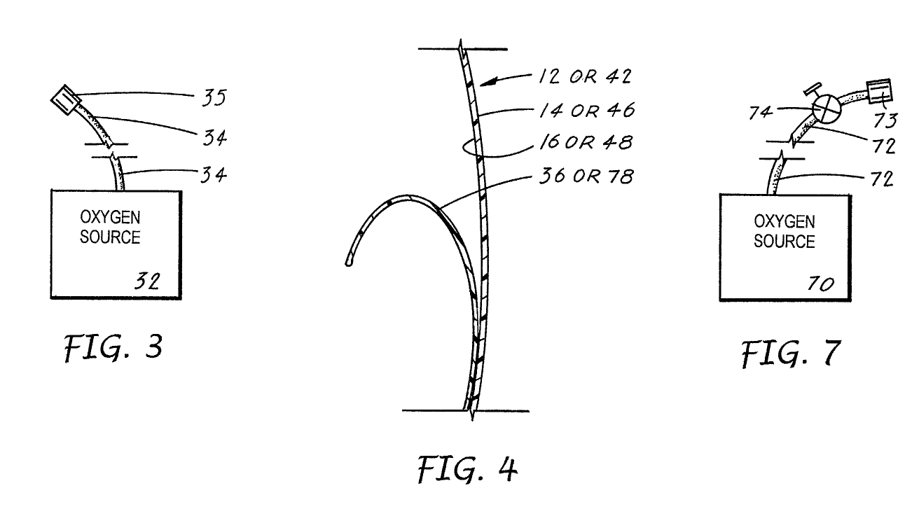

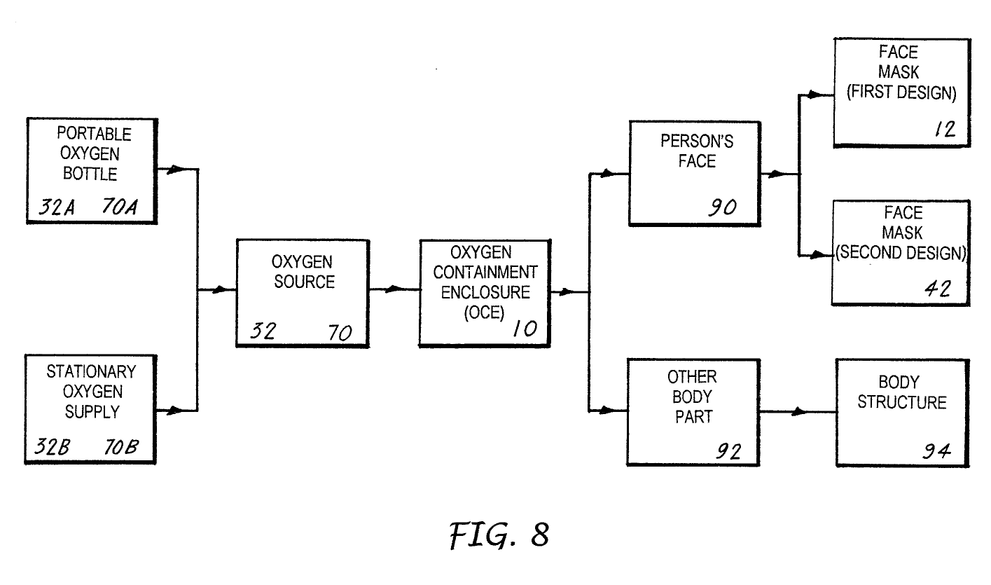

The face mask 12, which preferably has an oval shape, is formed of a relatively thin, clear plastic. The face mask 12 is comprised of an outer surface 14, an inner surface 16, a perimeter edge 18 preferably having a reinforcing bead 20, and a receptacle bore 24. As shown in FIGS. 1 and 2, an oxygen input receptacle 26, is inserted into and attached to the receptacle bore 24. The face mask 12 also comprises a plurality of air circulation bores 30, and requires an oxygen source 32, as shown in FIG. 3, that can be supplied from either a portable oxygen bottle 32A or a stationary oxygen supply 32B as shown in FIG. 8. The oxygen source 32 is supplied via a hose 34 that includes a connector 35 that is designed to be attached to the oxygen input receptacle 26.

As shown in FIGS. 1 and 2, the face mask 12 further comprises a sanitizing, peel-off film 36. The film 36 is releasleably attached, as shown in FIG. 4, to the inner surface 16 of the face mask 12 prior to forming the mask 12. Before the face mask 12 is placed over the person's face 90, the film 36 is peeled-off, thus insuring that the face mask 12 is sanitary prior to use.

The air circulation bores 30, as shown in FIGS. 1 and 2, have a diameter ranging from 0.0313 inches (0.080 cm) to 0.125 inches (0.318 cm). The bores 30 may be dispersed around the vicinity of a person's nose, as shown in FIGS. 1 and 2, a person's forehead, as shown in FIG. 2, or a combination of both.

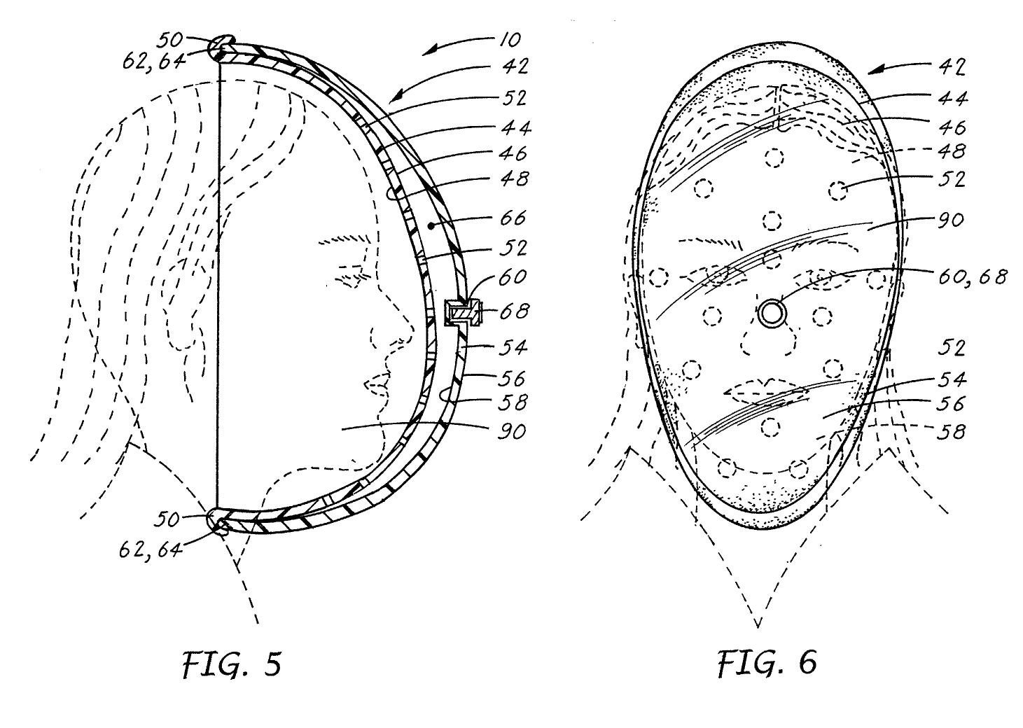

The second design configuration of the OCE 10, as shown in FIGS. 5 and 6, is comprised of a face mask 42 having an inner face mask 44 and an outer face mask 54. The inner face mask 44, has an outer surface 46, an inner surface 48, a perimeter attachment groove 50 and a multiplicity of oxygen passage bores 52. The bores 52 have a diameter ranging from 0.0313 inches (0.080 cm) to 0.125 inches (0.318 cm) and are dispersed over the entire area of the inner face mask 44.

The outer face mask 54, has an outer surface 56, an inner surface 58, a receptacle bore 60, and an inner edge 62 having a perimeter lip 64 that is dimensioned to be inserted into the perimeter attachment groove 50. When the lip 64 is inserted into the groove 50, the outer face mask 54 is attached to the inner face mask 44 which creates an airspace 66 located between the outer surface 46 of the inner face mask 44 and the inner surface 58 of the outer face mask 54, as shown in FIG. 5.

Both the inner and the outer face masks 44,54 are formed of a relatively thin, clear plastic, both have an oval shape and are dimensioned to cover the entire face 90 from the top of the forehead to the bottom of the chin, and from ear to ear.

The outer face mask 54 utilizes an oxygen input receptacle 68 that is inserted and attached to the receptacle bore 60. An oxygen source 70, as shown in FIG. 7, can be supplied by either a portable oxygen bottle 70A or a stationary oxygen supply 70B, as shown in FIG. 8. The oxygen source 70 is supplied through a hose 72 having a connector 73 that is designed to be attached to the oxygen input receptacle 68. The hose 72, as also shown in FIG. 7, can further include a means 74 for regulating the oxygen flow rate.

The second design configuration allows the applied oxygen to be entrapped between an air space 66 that is created between the outer surface 46 of the inner face mask 44 and the inner surface 58 of the outer face mask 54. The entrapped oxygen is then more evenly dispersed into the face by means of the multiplicity of oxygen passage bores 52 located on the inner face mask 44.

The sanitary, peel-off film 78, as shown in FIG. 4 is also applicable to the second design configuration. The peel-off film 78 is releaseably attached to the inner surface 48 of the inner face mask 44 and is peeled-off prior to placing the mask over a person's face 90, thus ensuring that the face mask 44 is sanitary prior to use.

As shown in FIG. 8, the oxygen containment enclosure 10 is preferably used with a face mask 12 or 42 that is placed over a person's face 90 during a facial treatment. However, as previously stated the OCE 10 can also be used in various medical procedures that utilize a concentration of oxygen, such as for burn victims. In these cases, the OCE 10 is designed and configured with a body structure 94 that conforms to the particular 10 body part 92 that is to be treated.

While the invention has been described in complete detail and pictorially shown in the accompanying drawings it is not to be limited to such details, since many changes and modifications may be made in the invention without departing from the spirit and scope thereof. Hence, it is described to cover any and all modifications and forms, which may come within the language and scope of the appended claims.

1. An oxygen containment enclosure shaped and dimensioned to be placed over a section of a person's body, said enclosure having means for receiving a regulated quantity of oxygen that is contained within the enclosure.

2. The enclosure as specified in claim 1, wherein said enclosure is comprised of a face mask substantially contoured and dimensioned to fit over a person's face, said face mask having:
a) an outer surface, an inner surface, a perimeter edge, and a receptacle bore,
b) an oxygen input receptacle inserted into and attached to the receptacle bore,
c) a plurality of air breathing bores, and
d) an oxygen source having a hose with a connector designed to be attached to said oxygen input receptacle.

3. The enclosure as specified in claim 2 wherein said face mask is formed of a relatively thin clear plastic.

4. The enclosure as specified in claim 3 wherein said face mask further comprises
a sanitizing, peel-off film releasablly attached to the inner surface of said mask, wherein said film is peeled-off prior to placing the mask over the person's face.

5. The enclosure as specified in claim 4 wherein said peel-off film is attached to said thin clear plastic prior to forming said face mask.

6. The enclosure as specified in claim 2 wherein the perimeter edge further comprises a reinforcing bead.

7. The enclosure as specified in claim 2 wherein said oxygen source further comprises a means for regulating the oxygen flow rate.

8. The enclosure as specified in claim 2 wherein said air circulation bores are dispersed around the area adjacent a person's nose and mouth.

9. The enclosure as specified in claim 8 wherein said air circulation bores are further dispersed in the vicinity of a person's forehead.

10. The enclosure as specified in claim 2 wherein said face mask has an oval shape.

11. The enclosure as specified in claim 2 wherein said air circulation bores have a diameter ranging from 0.0313 inches (0.080 cm) to 0.125 inches (0.318 cm).

12. The enclosure as specified in claim 2 wherein said face mask is dimensioned to cover the entire face from the top of the forehead to the bottom of the chin, and from ear to ear.

13. The oxygen dispensing enclosure as specified in claim 1 wherein said enclosure is comprised of a face mask having:
a) an inner face mask contoured and dimensioned to fit over a person's face, and having an outer surface, an inner surface, a perimeter attachment groove, and a multiplicity of oxygen passage bores dispersed over the entire area of said inner face mask,
b) an outer face mask having an outer surface, an inner surface, a receptacle bore, and an inner edge having a perimeter lip dimensioned to be inserted into the perimeter attachment groove, wherein when the lip is inserted into the groove, the outer face mask is attached to the inner face mask and an air space is created between the outer surface of said inner face mask and the inner surface of said outer face mask,
c) an oxygen input receptacle inserted into and attached to the receptacle bore, and
d) an oxygen source having a hose with a connector designed to be attached to said oxygen input receptacle.

14. The enclosure as specified in claim 13 wherein said inner and outer face masks are formed of a relatively thin clear plastic.

15. The enclosure as specified in claim 13 wherein said inner face mask further comprises a sanitizing peel-off film releaseably attached to the inside surface of said inner face mask, wherein said film is peeled-off prior to placing the mask over a person's face.

16. The enclosure as specified in claim 15 wherein said peel-off film is attached to said thin clear plastic prior to forming said inner face mask.

17. The enclosure as specified in claim 13 wherein said oxygen source further comprises a means for regulating the oxygen flow rate.

18. The enclosure as specified in claim 13 wherein said inner and outer face masks have an oval shape and are dimensioned to cover the entire face from the top of the forehead to the bottom of the chin and from ear to ear.

19. The enclosure as specified in claim 13 wherein the oxygen passage bores have a diameter ranging from 0.0313 inches (0.080 cm) to 0.125 inches (0.318 cm).
